(19) United States
(12) Patent Application Publication
(10) Pub. No.: US 2024/0095067 A1
(43) Pub. Date: Mar. 21, 2024

(54) RESOURCE CONTROL DEVICE, RESOURCE CONTROL SYSTEM, AND RESOURCE CONTROL METHOD

(71) Applicant: Nippon Telegraph and Telephone Corporation, Tokyo (JP)

(72) Inventors: Tetsuro NAKAMURA, Musashino-shi, Tokyo (JP); Akinori SHIRAGA, Musashino-shi, Tokyo (JP)

(21) Appl. No.: 18/275,344

(22) PCT Filed: Feb. 10, 2021
(86) PCT No.: PCT/JP2021/004998

§ 371 Date: Aug. 1, 2023

(51) Int. Cl. G06F 9/48

(52) U.S. Cl. CPC G06F 9/4881

(57) ABSTRACT

A resource control device includes: a controller unit configured to set resources related to IP cores of an FPGA 8 in which a user program executes a task; a common unit configured to create a user queue that is a set of queues having a plurality of priorities for each user program, and store tasks in the user queue; and a scheduler unit configured to select a task to be executed by any one of the IP cores by multi-stage scheduling in the user queue and between the user queues.

### TECHNICAL FIELD

The present invention relates to a resource control device, a resource control system and a resource control method, each of which is used for an FPGA.

### BACKGROUND ART

In recent years, FPGAs (field-programmable gate arrays) have been used with a plurality of convolutional neural networks for inference that are mounted as IP (intellectual property) cores (see NPLs 1 and 2). Such FPGAs can be employed in a variety of applications (for example, pose estimation, human recognition, object detection, etc.). End users do not have to rewrite IP cores to use FPGAs for executing tasks if they have a similar order of time complexity. The common processing executed in the FPGA is triggered as a host CPU program of each end user hands the processing over to the FPGA. Each processing in the FPGA is executed as a non-preemptive task, and then the execution results are returned to the CPU (central processing unit). Processing unique to each end user which cannot be implemented by common features of the FPGA is executed in the CPU program.

### CITATION LIST

### Non Patent Literature

[NPL 1] Xilinx Vitis-AI, [retrieved on Feb. 1, 2021], Internet (URL: https://github.com/Xilinx/Vitis-AI)
[NPL 2] M. Bacis, R. Brondolin and M. D. Santambrogio, “Blast Function: an FPGA-as-a-Service system for Accelerated Serverless Computing,” 2020 Design, Automation & Test in Europe Conference & Exhibition (DATE), Grenoble, France, 2020, pp. 852-857, doi: 10.23919/DATE48585.2020.9116333.

### SUMMARY OF INVENTION

### Technical Problem

When an FPGA is mounted on a cloud server to provide services, it is desirable to satisfy the requirements of abstraction, flexibility, controllability, and fairness.

The “abstraction” refers to that information in a cloud, such as an IP core mask, is not exposed to users. The “flexibility” refers to that necessary resource amounts, such as the number of IP cores in an FPGA, can be dynamically varied from outside the program. The “controllability” refers to that each user can set relatively the priority of a certain task over another task that the user has. The “fairness” refers to that FPGA resource amounts requested by the user do not conflict with the execution time actually obtained.

In a case where a plurality of programs of each user are simply operated as multiple processes, the requirements of abstraction, flexibility, controllability and fairness cannot be satisfied simultaneously.

The present invention is intended to appropriately share features of an FPGA among multiple users and improve the resource efficiency of the FPGA.

### Solution to Problem

For solving the problems stated above, a resource control device according to the present invention includes: a controller unit configured to set resources related to IP cores of an FPGA in which a program executes a task; a common unit configured to create a user queue that is a set of queues having a plurality of priorities for each program, and store tasks in the user queue; and a scheduler unit configured to select a task to be executed by any one of the IP cores by multi-stage scheduling in the user queue and between the user queues.

Other aspects will be described with embodiments for carrying out the invention.

### Advantageous Effects of Invention

According to the present invention, it is possible to appropriately share features of the FPGA among multiple users and improve the resource efficiency of the FPGA.

### BRIEF DESCRIPTION OF DRAWINGS

FIG. 1 is a configuration diagram of a resource control device for sharing accelerator devices in the present embodiment.

FIG. 2 is a diagram illustrating one example of operations in the resource control device.

FIG. 3 is a diagram illustrating one example of exclusive use of an IP core by the resource control device.

FIG. 4 is a diagram illustrating one example of the resource control device disposed in a user space of a host machine.

FIG. 5 is a diagram illustrating one example of the resource control device disposed in an OS kernel of the host machine.

FIG. 6 is a diagram illustrating one example of a resource control system in which a controller unit is disposed in a user space of another host machine.

FIG. 7 is a configuration diagram of a resource control device according to a comparative example.

### DESCRIPTION OF EMBODIMENTS

Hereinafter, a comparative example and an embodiment of the present invention will be described in detail with reference to the drawings.

### Comparative Example

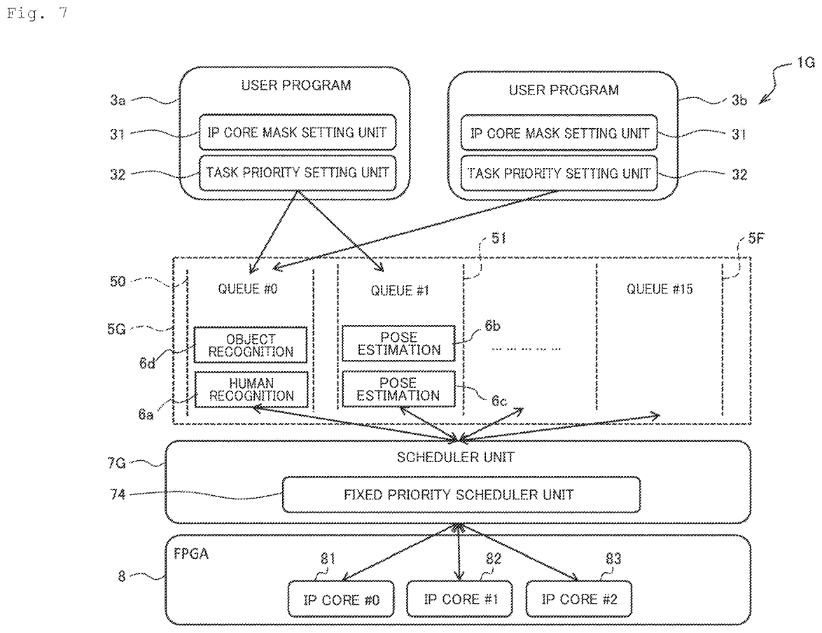

FIG. 7 is a configuration diagram of a resource control device 1G according to the comparative example.

The resource control device 1G includes an FPGA 8 mounted as hardware, and a CPU (not shown) executes a software program to implement a queue set 5G and a scheduler unit 7G. The resource control device 1G is, for example, a cloud server installed in a data center and providing services to each user via the Internet.

The FPGA 8 is provided with a plurality of IP cores 81 to 83, and executes a plurality of tasks in a non-preemptive manner at the same time. In FIG. 7, the IP core 81 is denoted as “IP core #0”, the IP core 82 as “IP core #1”, and the IP core 83 as “IP core #2”.

The queue set 5G includes a plurality of queues 50 and 51 to 5F. Since the priority of the queue 50 is lower than the priority of any of the other queues, it is indicated as “queue #0” in FIG. 7. Since the priority of the queue 51 is higher than the priority of the queue 50 but lower than the priority of any of the other queues, the queue 51 is indicated as “queue #1” in FIG. 7. Since the priority of the queue 5F is higher than the priority of any of the other queues, the queue 5F is indicated as “queue #15” in FIG. 7.

The scheduler unit 7G is provided with a fixed priority scheduler unit 74, schedules tasks 6a to 6d stored in the queues 50 and 51 to 5F in the order of priority of each queue, and allows the FPGA 8 to execute the tasks.

The resource control device 1G receives, for example, the tasks 6a to 6d from a plurality of user programs 3a and 3b, and allows the FPGA 8 to execute the tasks. Consequently, the user programs 3a and 3b are provided with an IP core mask setting unit 31 and a task priority setting unit 32. The task 6a is a task for human recognition. The tasks 6b and 6c are tasks for pose estimation. These tasks 6a to 6c are executed by the FPGA 8 in response to an instruction from the user program 3a. The task 6d is a task for objection recognition. The task 6d is executed by the FPGA 8 in response to an instruction from the user program 3b.

The IP core mask setting unit 31 sets which of the IP cores 81 to 83 of the FPGA 8 executes or does not execute a task. That is, a core mask can be directly designated by the user programs 3a and 3b for the IP core to be used. Therefore, internal information of a cloud server is exposed to users and abstraction is not guaranteed.

The task priority setting unit 32 sets the priority of each task. The task priority setting unit 32 determines a queue in which a task will be stored among the queues 50 and 51 to 5F of the queue set 5G. With the task priority setting unit 32, each user can relatively set the priority of a certain task over another task that the user has. In particular, the tasks 6b and 6c for pose estimation can be executed earlier than the task 6a for human recognition.

However, since the resource amount of the FPGA 8 to be used is determined inside the user programs 3a and 3b, the resource amount cannot be dynamically altered from the outside of the user programs 3a and 3b, and thus no flexibility is guaranteed.

The fixed priority scheduler unit 74 simply takes out tasks stored in the queue with higher priority in order and assigns them to the IP core. Therefore, the user cannot specify the resource amount that they want to use for the task. The resource amount of the FPGA 8 demanded by the user program may be different from the expected value of the actually obtained execution time, and thus fairness may be lost.

That is, in a case where a plurality of user programs are simply operated as multiple processes, the requirements of abstraction, flexibility, controllability and fairness cannot be satisfied simultaneously.

### Present Embodiment

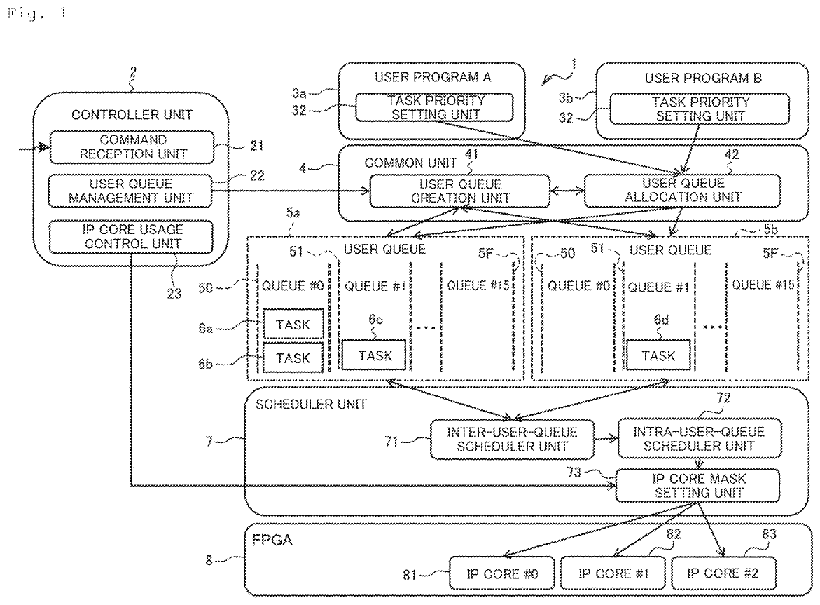

FIG. 1 is a configuration diagram of a resource control device 1 for sharing accelerator devices in the present embodiment. The resource control device 1 includes an FPGA 8 mounted as hardware, and a CPU (not shown) executes a software program to implement a controller unit 2, a common unit 4, user queues 5a and 5b, and a scheduler unit 7. The resource control device 1 is, for example, a cloud server installed in a data center and providing services to each user via the Internet.

The controller unit 2 includes a command reception unit 21, a user queue management unit 22, and an IP core usage control unit 23. The controller unit 2 has a function related to IP core setting, and sets resources related to IP cores 81 to 83 of the FPGA 8 in which a program executes a task. The controller unit 2 designates an IP core mask inside referring to vacancy of the IP cores and sets it in the scheduler unit 7. Thus, information inside the cloud server is not exposed to the user programs 3a and 3b. Since the controller unit 2 is provided with the command reception unit 21, resources can be dynamically controlled and flexibility can be provided.

The command reception unit 21 dynamically receives a resource control command from the user from the outside of the program. The resource control command is a command describing, for example, the number of IP cores to be used and whether or not the IP cores are exclusively used. In a case where the resource control command is not received, the command reception unit 21 notifies the user of non-reception.

Each time the user programs 3a and 3b are launched, the user queue management unit 22 notifies a user queue creation unit 41 of the common unit 4 that a user queue is created for the program.

The IP core usage control unit 23 controls occupancy/vacancy of the IP cores 81 to 83 of the FPGA 8 in a physical host, secures the number of IP cores designated by the command reception unit 21, and creates and manages a map fixedly and exclusively allocated to each user as necessary. The IP core usage control unit 23 notifies the scheduler unit 7 of allocation information every time the allocation information in which any of the IP cores 81 to 83 is allocated to a task is updated. In a case where the number of free IP cores is insufficient for a task to be executed by the user program, the IP core usage control unit 23 notifies the command reception unit 21 that the designation is not accepted. In a case where the resource control command is not received from the user, the command reception unit 21 notifies the user of non-reception.

The common unit 4 includes a user queue creation unit 41 and a user queue allocation unit 42. The common unit 4 prepares a user queue which is a set of queues having a plurality of priorities for each program, and stores tasks in the user queue.

The user queue creation unit 41 receives information on an available user queue from the controller unit 2, and creates a user queue for the program every time the program is newly deployed and launched.

The user queue allocation unit 42 selects a user queue corresponding to a user identifier given to the program when receiving the task from the program, and stores the task in the queue of the corresponding priority on the basis of the priority of the task in the user programs 3a and 3b. The user programs 3a and 3b are provided with a task priority setting unit 32 and set priority to each task.

The task priority setting unit 32 of the user program 3a sets a priority #0 to the tasks 6a and 6b, and then hands them over to the common unit 4; it also sets a priority #1 to the task 6c and then hands it over to the common unit 4.

The task priority setting unit 32 of the user program 3b sets a priority #1 to the task 6d and then hands it over to the common unit 4. The tasks 6a and 6b are stored in a queue 50 of the user queue 5a, and the task 6c is stored in a queue 51 of the user queue 5a. The task 6d is stored in a queue 51 of the user queue 5b.

The scheduler unit 7 includes an inter-user-queue scheduler unit 71, an intra-user-queue scheduler unit 72, and an IP core mask setting unit 73. The scheduler unit 7 selects a task to be executed by any of the IP cores 81 to 83 by multi-stage scheduling in the user queue and between the user queues. The inter-user-queue scheduler unit 71 selects the user queues 5a and 5b from which tasks will be taken out using a fair algorithm such as round-robin scheduling. These user queues 5a and 5b are sets of queues 50 and 51 having a plurality of priorities. The user queues 5a and 5b are queue sets having 16-scale priority, but only two queues are shown in the drawing.

The intra-user-queue scheduler unit 72 selects a task to be executed by an algorithm considering priority, such as taking out a task from a queue having the highest priority in the user queue selected by the inter-user-queue scheduler unit 71. The intra-user-queue scheduler unit 72 schedules tasks of the user independently of the inter-user-queue scheduler unit 71 in the user queues 5a and 5b, thereby enabling priority control of each task. That is, the controllability of the resource control device 1 is achieved by the intra-user-queue scheduler unit 72 and the inter-user-queue scheduler unit 71.

The IP core mask setting unit 73 receives information from the controller unit 2, sets an IP core mask to each task, and controls not to use an IP core which is not designated. The IP core mask herein refers to a designation of an IP core for a task.

The common unit 4 prepares a plurality of independent user queues 5a and 5b including queues of respective priorities. Further, the scheduler unit 7 includes the inter-user-queue scheduler unit 71 for determining which of the user queues 5a and 5b should be selected. The common unit 4 schedules the priority control algorithm of the intra-user-queue scheduler unit 72 and the algorithm of the inter-user-queue scheduler unit 71 together in multiple stages to guarantee fairness of resource allocation in the FPGA 8.

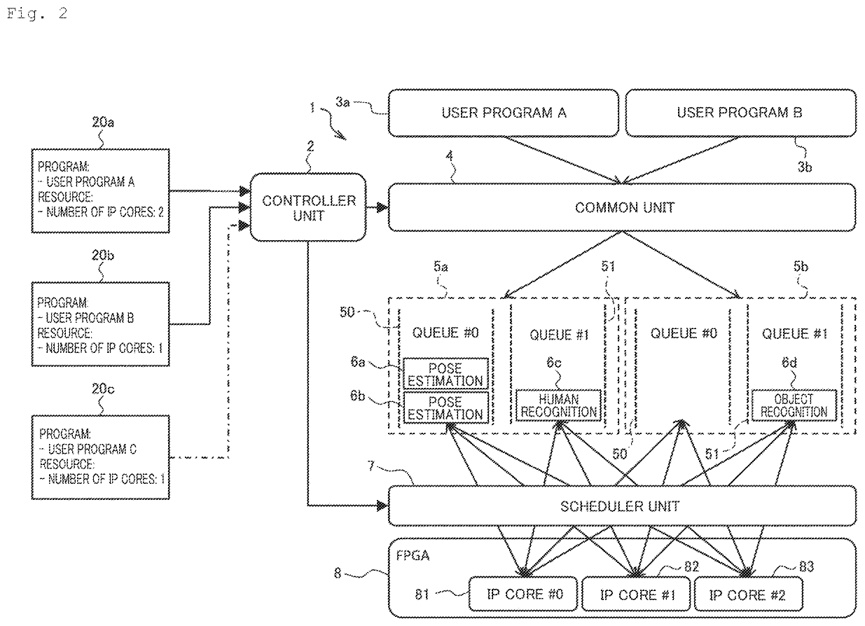

FIG. 2 is a diagram illustrating one example of operations in the resource control device 1.

Resource control commands 20a to 20c are successively sent to the controller unit 2 illustrated in FIG. 2.

First, the resource control command 20a is sent to the controller unit 2. The resource control command 20a describes that it is a deployment request related to a user program A (user program 3a) and that the number of IP cores to be used is two. The resource control command 20a is sent to the controller unit 2 together with the user program 3a, whereby the user program 3a is deployed and executed. The controller unit 2 controls mapping between two IP cores in the FPGA 8 and the user program 3a. At this time, two IP cores in the FPGA 8 are allocated to task execution of the user program 3a.

Next, the resource control command 20b is sent to the controller unit 2. The resource control command 20b describes that it is a deployment request related to a user program B (user program 3b) and that the number of IP cores to be used is one. Even if the user program 3a is already running, the resource control command 20b is sent to the controller unit 2 together with the user program 3b, whereby the user program 3b is deployed and executed. The controller unit 2 controls mapping between one IP core in the FPGA 8 and the user program 3b.

At this time, two IP cores in the FPGA 8 are allocated to task execution of the user program 3a, and remaining one IP core is allocated to task execution of the user program 3b.

Finally, the resource control command 20c is sent to the controller unit 2. The resource control command 20c is a command related to a user program C (not shown). The user programs 3a and 3b are already executed, and all IP cores in the FPGA 8 are allocated to the user programs 3a and 3b. Since the number of deployment requests exceeds the resource capacity, the controller unit 2 notifies the user of insufficient resource, and does not deploy the user program C.

When the user programs 3a and 3b are deployed, the intra-user-queue scheduler unit 72 of the scheduler unit 7 sets the ratio of the execution time of the user programs 3a and 3b to be 2:1 using an algorithm such as round-robin scheduling. The ratio of the execution time is equal to the ratio of the number of IP cores in the resource control commands 20a and 20b. Accordingly, the controller unit 2 can fairly allocate the IP cores of the FPGA 8 to the user programs 3a and 3b.

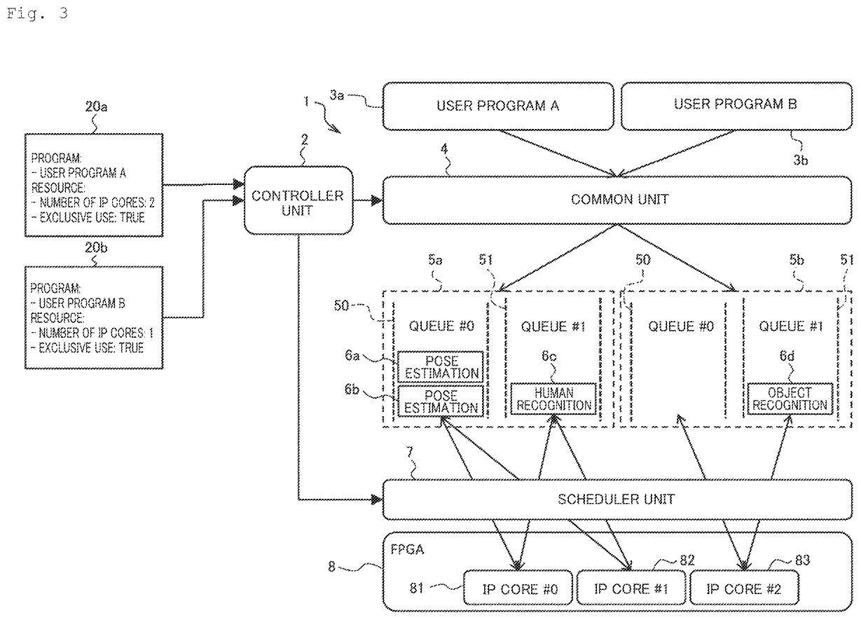

FIG. 3 is a diagram illustrating one example of exclusive use of an IP core by the resource control device 1.

The resource control commands 20a to 20b are sent to the controller unit 2 illustrated in FIG. 3.

The resource control command 20a describes that it is a deployment request related to the user program A (user program 3a), the number of IP cores to be used is two, and IP cores should be exclusively used.

The user sends the resource control command 20a to the controller unit 2 together with the user program 3a, whereby the user program 3a is deployed and executed. The controller unit 2 controls two IP cores in the FPGA 8, and manages exclusive mapping between the user program 3a and the IP cores. At this time, two IP cores in the FPGA 8 are exclusively allocated to task execution of the user program 3a.

The resource control command 20b describes that it is a deployment request related to the user program B (user program 3b), the number of IP cores to be used is one, and an IP core should be exclusively used.

Even if the user program 3a is already running, the user sends the resource control command 20b to the controller unit 2 together with the user program 3b, whereby the user program 3b is deployed and executed. The controller unit 2 controls mapping between the IP core in the FPGA 8 and the user programs 3a and 3b. At this time, two IP cores in the FPGA 8 are exclusively allocated to task execution of the user program 3a, and remaining one IP core is exclusively allocated to task execution of the user program 3b.

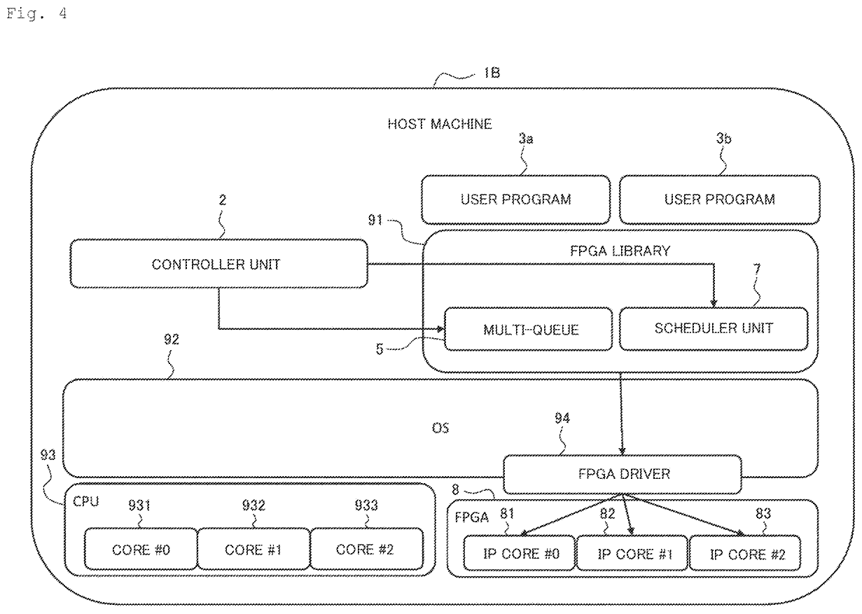

FIG. 4 is a diagram illustrating one example of the resource control device 1 disposed in a user space of a host machine 1B.

The host machine 1B is provided with a CPU 93 and the FPGA 8 as hardware layers, and an OS (operating system) 92 is installed therein. In a user space of the host machine 1B, the controller unit 2 and an FPGA library 91 are implemented, while the user programs 3a and 3b are deployed.

The FPGA library 91 includes a multi-queue 5 and a scheduler unit 7, and, in combination with the controller unit 2, functions as the resource control device 1 described above. Each time the user program is deployed, a new user queue is generated in the multi-queue 5. The scheduler unit 7 includes sections respectively corresponding to the inter-user-queue scheduler unit 71, an intra-user-queue scheduler unit 72, and the IP core mask setting unit 73, as shown in FIG. 1.

The controller unit 2 sends commands to the multi-queue 5 and the scheduler unit 7. The FPGA library 91 allows the FPGA 8 and the IP cores 81 to 83 to execute tasks via an FPGA driver 94 installed in the OS 92.

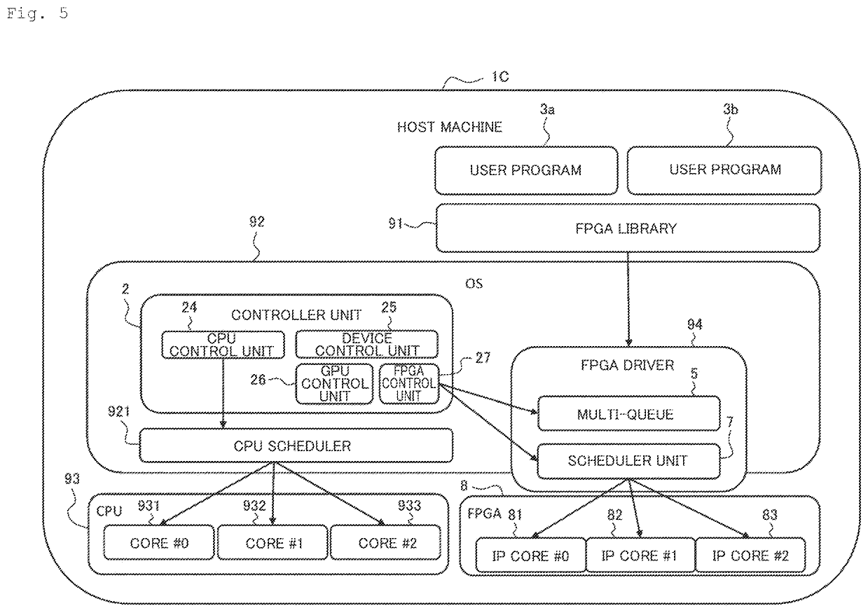

FIG. 5 is a diagram illustrating one example of the resource control device disposed in a kernel space of an OS 92 in a host machine 1C.

The host machine 1C is provided with a CPU 93 and the FPGA 8 as hardware layers, and the OS 92 is installed therein. The controller unit 2, a CPU scheduler 921, and an FPGA driver 94 are installed in a kernel space of the OS 92 of the host machine 1B. In a user space of the host machine 1C, the FPGA library 91 and the user programs 3a and 3b are deployed.

The controller unit 2 includes a CPU control unit 24, a device control unit 25, a GPU (graphic processing unit) control unit 26, and an FPGA control unit 27.

The CPU control unit 24 is a section for controlling cores 931 to 932 constituted in the CPU 93 and notifies the CPU scheduler 921 of instructions.

The GPU control unit 26 is a section for controlling a GPU (not shown). The FPGA control unit 27 is a section for controlling the FPGA 8, and includes sections respectively corresponding to the command reception unit 21, the user queue management unit 22, and the IP core usage control unit 23, as illustrated in FIG. 1.

The FPGA driver 94 includes the multi-queue 5 and the scheduler unit 7. The multi-queue 5 and the scheduler unit 7 are controlled by the FPGA control unit 27. Each time the user program is newly deployed, a new user queue is generated in the multi-queue 5. The scheduler unit 7 includes sections respectively corresponding to the inter-user-queue scheduler unit 71, an intra-user-queue scheduler unit 72, and the IP core mask setting unit 73, as shown in FIG. 1.

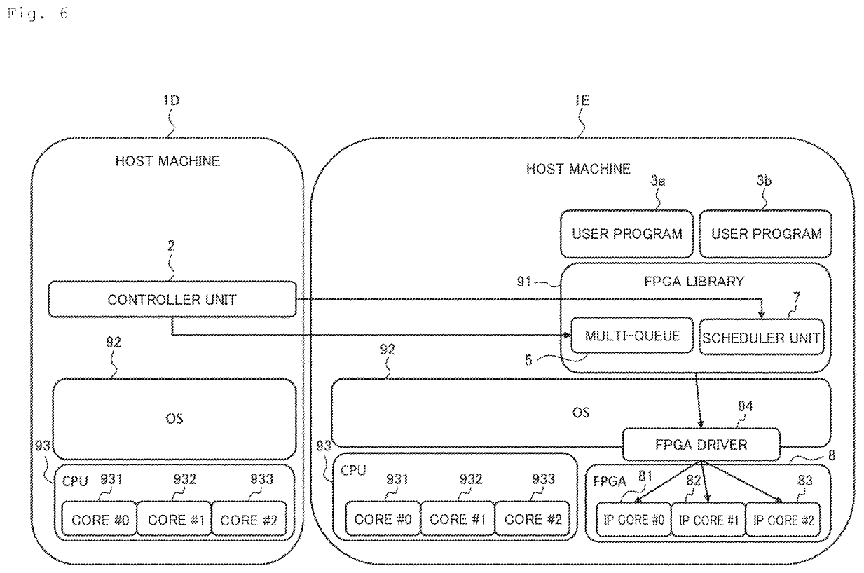

FIG. 6 is a diagram illustrating one example of the resource control system in which the controller unit 2 is disposed in a user space of another host machine 1D.

The resource control system shown in FIG. 6 includes a host machine 1D in which a controller unit 2 is arranged, as well as a host machine 1E. The host machine 1D is provided with a CPU 93 as a hardware layer, and an OS 92 is installed therein. The controller unit 2 is implemented in a user space of the host machine 1D. The controller unit 2 has the same functions as the controller unit 2 shown in FIG. 1.

The host machine 1E is provided with a CPU 93 and the FPGA 8 as hardware layers, and the OS 92 is installed therein. In a user space of the host machine 1E, an FPGA library 91 is implemented, while the user programs 3a and 3b are deployed. The FPGA library 91 has the same functions as the FPGA library 91 shown in FIG. 1.

The FPGA library 91 includes a multi-queue 5 and a scheduler unit 7, and, in combination with the controller unit 2 of the host machine 1D, functions as the resource control device 1 described above. Each time the user program is deployed, a new user queue corresponding to the user program is generated in the multi-queue 5. The scheduler unit 7 includes sections respectively corresponding to the inter-user-queue scheduler unit 71, an intra-user-queue scheduler unit 72, and the IP core mask setting unit 73, as shown in FIG. 1.

The controller unit 2 sends commands to the multi-queue 5 and the scheduler unit 7. The FPGA library 91 allows the FPGA 8 and the IP cores 81 to 83 to execute tasks via an FPGA driver 94 installed in the OS 92.

### Advantageous Effects

Advantageous effects of the resource control device, the resource control system and the resource control method, according to the present invention, will be described hereinbelow.

<<Claim 1>>

A resource control device, comprising:
a controller unit configured to set resources related to IP cores of an FPGA in which a program executes a task;
a common unit configured to create a user queue that is a set of queues having a plurality of priorities for each program, and store tasks in the user queue; and
a scheduler unit configured to select a task to be executed by any one of the IP cores by multi-stage scheduling in the user queue and between the user queues.

Accordingly, it is possible to appropriately share features of the FPGA among multiple users and improve the resource efficiency of the FPGA.

<<Claim 2>>

The resource control device according to claim 1, wherein the scheduler unit includes:
an inter-user-queue scheduler unit configured to select user queues from which tasks are to be taken out; and
an intra-user-queue scheduler unit configured to extract a task from a queue with the highest priority out of queues each of which has a registered task, among the user queues selected by the inter-user-queue scheduler unit.

Accordingly, it is possible to enable multi-stage scheduling between multiple users and in the user, and improve the resource efficiency of the FPGA.

<<Claim 3>>

The resource control device according to claim 1, wherein the scheduler unit further includes an IP core mask setting unit configured to control such that a non-designated IP core is not used for each task.

Accordingly, it is possible to enable multi-stage scheduling between multiple users and in the user, and improve the resource efficiency of the FPGA.

<<Claim 4>>

The resource control device according to claim 1, wherein the controller unit includes an IP core usage control unit configured to secure the number of IP cores designated by the program, create and control a map in which IP cores are fixedly allocated to each program when receiving a designation of exclusive use of the IP cores, and
the IP core usage control unit is configured not to receive the designation if the total number of IP cores newly designated by the program exceeds the number of IP cores in the FPGA.

Accordingly, it is possible to appropriately share features of the FPGA among multiple users.

<<Claim 5>>

The resource control device according to claim 1, wherein the common unit includes a user queue creation unit configured to create a user queue for a new program each time the program is started.

Accordingly, it is possible to fairly share resources of the FPGA among multiple users.

<<Claim 6>>

The resource control device according to claim 1, wherein the common unit is configured to, when receiving a task from the program, select a user queue related to the program based on an identifier, and register the task to the user queue based on a task priority.

Accordingly, it is possible to fairly share resources of the FPGA among multiple users.

<<Claim 7>

A resource control system, comprising:
a controller unit configured to set resources related to IP cores of an FPGA in which a program executes a task;
a common unit configured to create a user queue that is a set of queues having a plurality of priorities for each program, and store tasks in the user queue; and
a scheduler unit configured to select a task to be executed by any one of the IP cores by multi-stage scheduling in the user queue and between the user queues.

Accordingly, it is possible to appropriately share features of the FPGA among multiple users and improve the resource efficiency of the FPGA.

<<Claim 8>>

A resource control method, comprising:
setting, by a controller unit, resources related to IP cores of an FPGA in which a program executes a task;
creating, by a common unit, a user queue that is a set of queues having a plurality of priorities for each program, and storing tasks in the user queue; and
selecting, by a scheduler unit, a task to be executed by any one of the IP cores by multi-stage scheduling in the user queue and between the user queues.

Accordingly, it is possible to appropriately share features of the FPGA among multiple users and improve the resource efficiency of the FPGA.

### REFERENCE SIGNS LIST

1, 1G Resource control device
1B, 1C, 1D, 1E Host machine
2 Controller unit
20a to 20c Resource control command
21 Command reception unit
22 User queue management unit
23 IP core usage control unit
24 CPU control unit
25 Device control unit
26 GPU control unit
27 FPGA control unit
3a User program
3b User program
31 IP core mask setting unit
32 Task priority setting unit
4 Common unit
41 User queue creation unit
42 User queue allocation unit
5 Multi-queue
5a, 5b User queue
5G Queue set
50, 51 to 5F Queue
6a to 6d Task
7 Scheduler unit
7G Scheduler unit
71 Inter-user-queue scheduler unit
72 Intra-user-queue scheduler unit
73 IP core mask setting unit
74 Fixed priority scheduler unit
8 FPGA
81 to 83 IP core
91 FPGA library
92 OS
921 CPU scheduler
93 CPU
931 to 933 Core
94 FPGA driver

1. A resource control device, comprising:
a processor; and
a memory device storing instructions that, when executed by the processor, configure the processor to:
set resources related to Intellectual Property (IP) cores of a Field-Programmable Gate Array (FPGA) in which a program executes a task;
create a user queue that is a set of queues having a plurality of priorities for each program, and store tasks in the user queue; and
select a task to be executed by any one of the IP cores by multi-stage scheduling in the user queue and between the user queues.

2. The resource control device according to claim 1, wherein the processor is configured to:
select user queues from which tasks are to be taken out; and
extract a task from a queue with the highest priority out of queues each of which has a registered task, among the selected user queues.

3. The resource control device according to claim 1, wherein the processor is configured to control such that a non-designated IP core is not used for each task.

4. The resource control device according to claim 1, wherein the processor is configured to secure the number of IP cores designated by the program, create and control a map in which IP cores are fixedly allocated to each program when receiving a designation of exclusive use of the IP cores, and
wherein the processor is configured not to receive the designation if the total number of IP cores newly designated by the program exceeds the number of IP cores in the FPGA.

5. The resource control device according to claim 1, wherein the processor is configured to create a user queue for a new program each time the program is activated.

6. The resource control device according to claim 1, wherein the processor is configured to, when receiving a task from the program, select a user queue related to the program based on an identifier, and register the task to the user queue based on a task priority.

7. A resource control system, comprising:
a controller unit, implemented using one or more processors, configured to set resources related to Intellectual Property (IP) cores of a Field-Programmable Gate Array (FPGA) in which a program executes a task;
a common unit implemented using one or more processors, configured to create a user queue that is a set of queues having a plurality of priorities for each program, and store tasks in the user queue; and
a scheduler unit, implemented using one or more processors, configured to select a task to be executed by any one of the IP cores by multi-stage scheduling in the user queue and between the user queues.

8. A resource control method, comprising:
setting resources related to Intellectual Property (IP) cores of a Field-Programmable Gate Array (FPGA) in which a program executes a task;
creating a user queue that is a set of queues having a plurality of priorities for each program, and storing tasks in the user queue; and
selecting a task to be executed by any one of the IP cores by multi-stage scheduling in the user queue and between the user queues.
